(19) United States
(12) Patent Application Publication
(10) Pub. No.: US 2018/0306913 A1
(43) Pub. Date: Oct. 25, 2018

(54) Radio-based position determination with high-precision delay in the transponder

(71) Applicant: Oliver Mark Bartels, Muenchen (DE)

(72) Inventor: Oliver Mark Bartels, Muenchen (DE)

(21) Appl. No.: 15/768,538

(22) PCT Filed: Aug. 24, 2016
(86) PCT No.: PCT/EP2016/001426

§ 371 Date: Apr. 14, 2018

(30) Foreign Application Priority Data
Oct. 16, 2015 (DE) 10 2015 013 453.1
Jul. 6, 2016 (DE) 10 2016 008 217.8
Jul. 9, 2016 (DE) 10 2016 008 390.5

(51) Int. Cl. G01S 13/76; G01S 13/87; G01S 15/74; G01S 17/74

(52) U.S. Cl. CPC G01S 13/767; G01S 13/878; G01S 7/4008; G01S 17/74; G01S 15/74

(57) ABSTRACT

The invention describes a novel system for measuring short distances using the propagation time of radio signals between at least one interrogation unit and a transponder, whereby a disturbance of the transponder's response signal by its own request signal is excluded by means of a highly precise delay of the request in the transponder. The delay is realized with quartz accuracy and the necessary precision in that it takes place in a digital or analog register chain, whose register clock is kept phase synchronous with the interrogation signal, that a variable delay of the interrogation signal takes place in the interrogation unit and that this delay is adjusted by one register clock period at the synchronous time preferably by means of a binary search by means of the recognizable jump of the total running time-round trip.

The invention is based on the task of precisely measuring the distance between a moving object and at least a stationary measuring station by means of a radio signal.

For this purpose, a time measurement in the time domain, known from RADAR systems of all kinds, as well as an indirect time measurement by an analysis of e.g. a chirp signal in the frequency domain are suitable. These measurements can be supported by angle measurements, whereby a direct estimation of the angle of the incoming signal is also possible by means of phased array antenna or MIMO.

The usual structure of such a system consists of several fixed interrogation stations, which send an interrogation signal to the moving transponder, which reacts to the interrogation with a response signal, which in turn is received by one or more interrogation stations and the distance is calculated from the signal delay due to the constant speed of light. The exact position results from triangulation. Such systems are known in aviation as secondary radar and DME (Distance Measurement Equipment). A variety of literature is available on these systems, compare EP0740801B1, WO2007131987A1, U.S. Pat. No. 3,969,725A, DE165546.

It is also conceivable that several stations transmit signals correlated to each other and the evaluation of the transit time differences takes place in the mobile unit. Satellite-based positioning systems such as GPS, Glonass and Galileo work on this basis. The exact determination of the transit time differences is also carried out here in the time domain by means of correlation.

In the area of large distances with accuracy requirements in the metre range and with a clear view of the sky, all these systems work excellently. An unsatisfactorily solved problem so far is the exact positioning in the close range of the measuring stations with accuracies in the cm range, especially in closed buildings.

The core problem with travel time measurement in the near range is the high speed of light, which leads to travel times in the nanosecond range with direct measurement of short distances. Therefore, the direct approach of runtime-based RADAR systems for short distances has so far been associated with extreme difficulties. The transition to slower media such as sound is possible in principle, but also delivers only limited good results depending on the application due to the media properties. For example, distance measuring systems in motor vehicle bumpers are an excellent parking aid, but the positioning of robots leaves a lot to be desired.

A major problem here is that the signal propagation time is shorter than the pulse duration, which means that the RADAR receiver is blocked by its own transmitter with a strong signal exactly when the object to be measured responds directly by reflection or directly by means of a transponder.

With an indirect measurement in the frequency domain, e.g. using FMCW—compare DE19743132C2—or chirp signals—compare U.S. Pat. No. 8,976,060B2—one encounters the problem that a clear identification of the shortest path is not possible due to the regulatorically limited frequency bands.

Especially in a built-up environment, the radio signal will always propagate over several paths, but only the shortest direct path is of interest for transit time measurement. Due to the limitation of the frequency range, a natural law limitation of system accuracy results due to the application of the well-known Cramer Rao barrier—see Sahinoglu, Z., Gezici, S & Guvenc, I. (2008), Ultra-wideband Positioning Systems, Cambridge—to the necessary Fourier transformation.

This problem is significantly alleviated by a measurement in the time domain, because the system simply reacts to the first incoming signal—the wavefront—which, at constant speed of light, is naturally the signal with the shortest distance.

Therefore, a measurement in the time domain would be preferable, but so far it has failed because the query signal to the transponder must be delayed with a high precision in the picosecond range so that the receiver in the interrogation unit measures the transponder's echo and not its own query signal.

According to the state of the art, an analog delay or frequency conversion would therefore be an option. A frequency conversion into another band would be possible in principle, but fails because of the frequency scarcity and the interference signals converted in the process. If a narrow-band filter were used, the system would measure the group delay of the filters instead of the propagation time measurement, which unfortunately depends on frequency and temperature, for example. This also applies to the delay caused by SAW filters due to expansion of the carrier material.

For the general state of the art for measuring short distances in the time domain, please refer to DE19941428A1 as an example. This document describes the use of a runtime-based short-distance measurement for use in a locking system using a delay element with a fixed runtime in the transponder. As discussed, however, this arrangement is not expected to be very accurate, which is why it is only intended for approximate distance estimation to block unwanted locking operations when the key is too far away from the lock.

In order to adjust the delay time within the interrogator or transponder, state-of-the-art devices with variably adjustable delay elements are also known, as shown in DE10255880A1, although the high-precision reference is missing for the precise setting of the delay time in the system, which is why the variable delay element is used here to achieve another objective, namely the detection of a relay attack, and not to increase precision. The discussed dependency of the exact delay time of the variable delay elements on environmental conditions independent of the specified setpoint also prevents a permanently stable calibration with external measuring equipment.

The invention is therefore based on the task of enabling distance measurement by means of transit time measurement in the time domain similar to a RADAR system at short distances by the fact that a highly precise delay of the interrogation signal takes place in the transponder and thus the response signal is returned to the interrogation signal with an exactly defined delay.

According to the invention, the problem is solved by the system described in claim 1, the function of which is explained below using a design example:

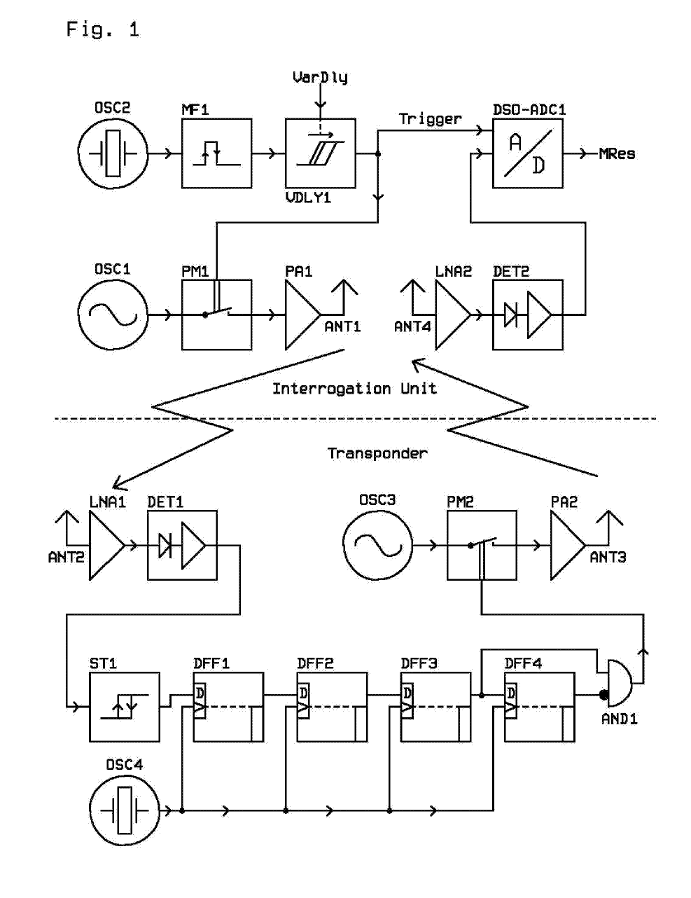

The example in FIG. 1 shows an inventive system. In the upper part of the image, the interrogation unit is shown schematically, in the lower part, the transponder.

First, the OSC1 oscillator generates a high-frequency carrier signal, preferably in the microwave or millimeter wave band, which is modulated via the PM1 pulse modulator and can be transmitted as an interrogation signal via the ANT1 antenna after amplification via the PA1 power amplifier.

The polling pulse is now generated in a time grid which is specified by the significantly slower quartz-precise clock generator OSC2. With each rising edge of the OSC2, a short pulse with a duration defined by the monoflop is generated by means of the monoflop 1. The division into FIG. 1 is schematic for a better understanding, in reality all these functions will be digitally implemented and derived from an accurate high frequency quartz clock.

The pulse is then delayed by the variable delay element VDLY1, the delay should be in the picosecond range and may therefore contain analog elements. A high absolute accuracy is not required here, only a temporal stability of the delay. Another preferred approach according to subclaim is the integrated generation and delay of the OSC2 output signal as DDS sine with phase shift adjustment.

After analog filtering and evaluation by means of a fast comparator with downstream monoflop or other pulse duration limitation, e.g. by combination with a further signal, the interrogation pulse is then also available.

Alternatively, the frequency ramp can be delayed or phase-shifted to generate a chirp pulse for the ingenious chirp detector described in a later section in order to influence its zero crossing over time. It is also conceivable to adjust a frequency offset between transmitter and receiver on one of the PLL synthesizers.

The interrogation pulse generated in this way is then fed to the pulse modulator PM1 and thus generates the high-frequency interrogation signal emitted by the antenna ANT1, which is received by the transponder via the antenna ANT2.

There it is amplified by a Low Noise Amplifier LNA1 and fed to the fast detector DET1. If the output signal of the DET1 detector exceeds a certain value, the Schmitt trigger ST1 triggers and applies a signal to the input of the DFF1 to DFF4 register chain consisting of the D-Flip-Flops.

This is taken over with the next edge of the register clock generated by the local oscillator OSC4 and, a few clocks later, is fed to the pulse modulator PM2 for the response signal via the AND gate AND1, if a signal has not already been generated in the previous clock cycle. This blocks the response signal one clock later, delayed by DFF4, by means of the inverted input of AND1.

This effectively limits the pulse length, but in a particularly preferred design according to subclaim, a certain pattern for a response pulse can be requested via further logic gates similar to AND1 at the preceding outputs of the DFF1, so that a response pulse is generated.

The PM2 pulse modulator now generates the response amplified by the PA2 power amplifier and transmitted via the ANT3 antenna by modulating the carrier provided by OSC3—this carrier is preferably in the same frequency band as that of the request signal.

This is now received by the interrogation station of ANT4, amplified via the Low Noise Amplifier LNA2, demodulated in the detector DET2 and evaluated by the A/D converter DSO-ADC. In a preferred version according to subclaim, the signal is digitized after the trigger from the polling pulse using a technology comparable to that known from the literature for digital storage oscilloscopes, whereby an exact determination of the propagation time is possible taking into account the delay caused by the register chain.

One could now think that the delay by the register chain is very undefined, because the time between the arrival of the input signal from ST1 at the D input of DFF1 and the edge of OSC4 at the clock input of DFF1 is undetermined by the oscillations of OSC4 asynchronous to OSC2.

However, both oscillators as quartz oscillators are precise enough to maintain the phase position for a longer period of time even without synchronization. This is especially true for the TCXO and OCXO versions. Therefore, the dimensioned frequencies of both oscillators must be in a fixed known relationship to each other.

This is where the special trick of the invention comes in, which leads to the surprising result that the register chain causes a very exact deceleration:

Using a controller—microcontroller, DSP or FPGA—the delay time at input VarDly of delay element VDLY1 is now changed in relation to the frame clock. This change can be made in a preferred design according to subclaim first in coarse and then in fine steps in the context of a binary search.

If the time of the clock at the input of DFF1 is exceeded, the transponder's response signal is immediately delayed by an entire clock period. This delay is so large that it is immediately noticeable when the controller evaluates the measurement result MRes and the search algorithm receives the information that the clock time has been exceeded.

It is therefore clear that the clock time must lie before this delay set in this step, otherwise—without this delay occurring by one clock period—clearly afterwards. As a result, the search range for the optimum deceleration value can be halved immediately.

Similar to an A/D converter with successive approximation, a range of 2 to the power of n delay values is therefore completely covered in only n steps. In this way, the delay time at which the interrogation signal is minimally delayed in the register chain is found within a very short time, namely in the example by three quartz-accurate cycles of the OSC4.

Since standard TCXO crystal oscillators already have an accuracy of less than 1E-6, an accuracy in the picosecond range is guaranteed, even with a delay in the microsecond range, as is necessary for a transit time measurement at short distances.

According to the subclaim, a long-term synchronization of the frequency of OSC2 with OSC4 can also be easily performed by a frequency control loop, which compares the frequency against the period of the incoming pulses according to ST1, the TCXO have a control input for this purpose.

It can now be argued that in this arrangement the DFF1 is driven directly into a metastable state, but particularly suitable circuits are available to avoid this. According to the subclaim, the same circuit technology as used in phase-frequency detectors of phase locked loops (PLL), which also require picosecond accuracies and have to deal with this problem, is solved according to the state of the art in the field of PLL.

If the distance to be measured changes now, it may no longer be necessary to perform the complete binary search; instead, the delay can be adjusted incrementally in small steps.

If the preferred version according to the subclaim is used, i.e. the transponder reacts only to a certain pulse pattern by inserting further logical links in the register chain, several different transponders can be used simultaneously in the system, of which only one responds at a time depending on the request signal. However, MF1 must generate this pattern in the interrogation unit and the pattern should have certain properties for reliable detection, e.g. pre-emphasis shifted edges of the identification transitions following the first transition to time measurement.

The expected pattern will be made programmable in a particularly preferred design, e.g. by a controller in the transponder, which controls the logic of the register chain and selects the desired pattern—e.g. via ROM or RAM—, whereby the selection can be determined dynamically from the system configuration. The use of feedback shift registers and other approaches from coding theory is also conceivable.

An alternative is the use of analog sample/hold stages in the register chain or of a CCD chain, also in combination with digital elements, in order to avoid the problem of an unclear threshold value with weak signals from ST1. It is also conceivable to trigger an analog/digital converter as an analog register with subsequent digital signal processing in order to be able to process a disturbed wavefront, for example.

In addition, a complete determination of the position of the transponder in space can be made with several query stations; the corresponding calculations are known under the term of triangulation.

The use of fast-switching light sources and light receivers instead of radio transmission is also conceivable; in theory, the invention can also be used for ultrasonic systems to increase accuracy.

The invention makes it possible to reliably measure even short distances in space by radio, as is already possible for longer distances using RADAR or satellite navigation.

In order to implement the system, there is the problem of making it as technically stable and cost-effective as possible.

The problem is solved by the variants described in claims 11 to 20, the function of which is explained below using a design example:

The example in FIG. 1 again shows the system according to the invention.

First, the OSC1 oscillator generates a high-frequency carrier signal, preferably in the microwave or millimeter wave band, which is modulated via the PM1 pulse modulator and can be transmitted as an interrogation signal via the ANT1 antenna after amplification via the PA1 power amplifier.

As an invention, a particularly fast pulse modulator PM1 is now used, resulting in a broadband or ultra-wide band signal. This reduces the effect of the Cramer Rao barrier on system accuracy.

In order to prevent the signal emitted by ANT3 from immediately triggering another query by mistake, the DET1 receiver is now disabled shortly before to shortly after transmission in accordance with the underclaim; this can be done by preliminary derivation of the inhibit signal at DFF2 and ordeal of the same with the output signals from DFF3 to DFF4. Alternatively, the output of DFF4 resets the entire register chain according to subclaim.

In order to determine the input of the signal at the receiver (DET1) particularly precisely, the use of a correlation receiver is conceivable, whereby the effect of multipath on the correlation according to subclaim can subsequently be reduced by evaluating the edge received from the A/D converter (DSO-ADC1). This correction is possible even for simple pulse signals.

The use of a commercially available I/Q quadrature demodulator as well as a commercially available broadband detector is conceivable both as a receiver and as a correlation receiver. According to the subclaim, an additional RMS signal can be set in relation to the received envelope.

When using an I/Q quadrature demodulator, squaring and subsequent summing of the I/Q outputs is recommended. This can be done directly by means of analog multipliers or also by digital signal processing, preferably using the CORDIC algorithm. The additional phase information obtained can be used to detect a stable carrier and, if necessary, correlate with it. In addition, despite triggering a first pulse processing in the register chain (DFF1 to DFF4), the transmission of a response can be subsequently suppressed if the received carrier is not sufficiently stable.

As the first register (DFF1), the analog sample/hold register of an A/D converter connected downstream of the demodulator or detector can also be used if an I/Q quadrature demodulator or broadband detector is used.

Furthermore, pulse processing can be suppressed if the interrogation code associated with the transponder is not recognized as modulation on the carrier; phase modulation is particularly advantageous when using an I/Q quadrature demodulator.

Correct control of the A/D converter to evaluate the response is particularly important for high system accuracy. On the one hand, this determines the exact signal propagation time, whereby the accuracy can be increased by interpolation or fitting.

On the other hand, it can be used to correct the measured propagation time in the transmitting direction due to the symmetrical transmission path from the incoming edge including all interference by multipath. For this purpose, the measured edge against the behaviour and in particular the trigger threshold of the receiver in the transponder is compared arithmetically; the trigger threshold can be shifted arithmetically on the basis of the comparison and a time correction can thus be carried out.

For this purpose, however, a clock synchronous to the recording trigger must be provided for the converter. While such converters including FIFO are commercially available—e.g. AD6641 from Analog Devices—a further trick is required to shift the clock flanks.

According to subclaims, this is achieved either by using a second similar delay element similar to that for the trigger (VDLY1) or by obtaining the frame clock for the modulator (PM1) subsequently by dividing the clock for the A/D converter. In addition, PLL loops or digital direct synthesis can be used to achieve a clock shift. Conversely, the clock shift can also be used to phase adjust a carrier itself or the reference clock of the PLL for its generation or the clock for the D/A converter for pulse shaping in order to further increase the accuracy.

When using vector modulators—also for pulse generation—and vector demodulators, the additional implementation of an established radio standard makes sense; according to subclaim, the distance measurement function can be triggered e.g. by evaluating the packet start or another feature such as a preamble. The content of the data package can activate the transponder response.

The necessary delay elements (VDLY1) can be either clock-based or, if the corresponding processing capacity is available, by interpolation, especially of an I/Q signal for the vector modulator, or by resampling in digital signal processing. A combination with the clock-based delay is also conceivable.

If necessary, pre-distortion can also be carried out according to known multipath characteristics, which is calculated either from previous transponder responses or e.g. from the Channel Equalization, especially if further radio standards are used.

Thus, for example, a conventional WLAN, LTE or Bluetooth system can be used for extremely precise distance determination by adding a few additional hardware. This takes particular account of the cost-benefit aspect.

The invention also makes it possible to measure even short distances in space at particularly low cost by means of radio.

The invention also provides a novel detector for Chirp pulses with short latency and high temporal precision, which can be used if the system described above is to be implemented with Chirp pulses, which can have clear advantages with regard to the utilization of the available frequencies, taking into account the Cramer Rao barrier and multipath.

The invention is therefore also based on the task of constructing a detector for chirp pulses for use in a measuring system, which precisely determines the distance between a moving object and at least a stationary measuring station by means of a radio signal.

Chirp pulses are high-frequency pulses whose frequency increases or decreases continuously—usually linearly—during the pulse duration. For example, you follow a function with the fundamental frequency f0 and a time-dependent frequency variation k t.

Such chirp pulses are used, for example, in radar systems with pulse compression. A common detection method is the use of a filter, especially SAW filters, with frequency-dependent group delay. If, for example, a chirp pulse with an initially low and then linearly increasing frequency is present for low frequencies in the pass band, a higher group delay is provided than for higher frequencies in the filter; the difference between the smallest and largest group delay in the pass band should then correspond approximately to the pulse duration. Thus, all signal components arrive at the filter output simultaneously and add up to a large short total peak, which can be easily detected, e.g. by means of a fast diode detector. For details on the state of the art, see U.S. Pat. No. 5,298,962A as an example.

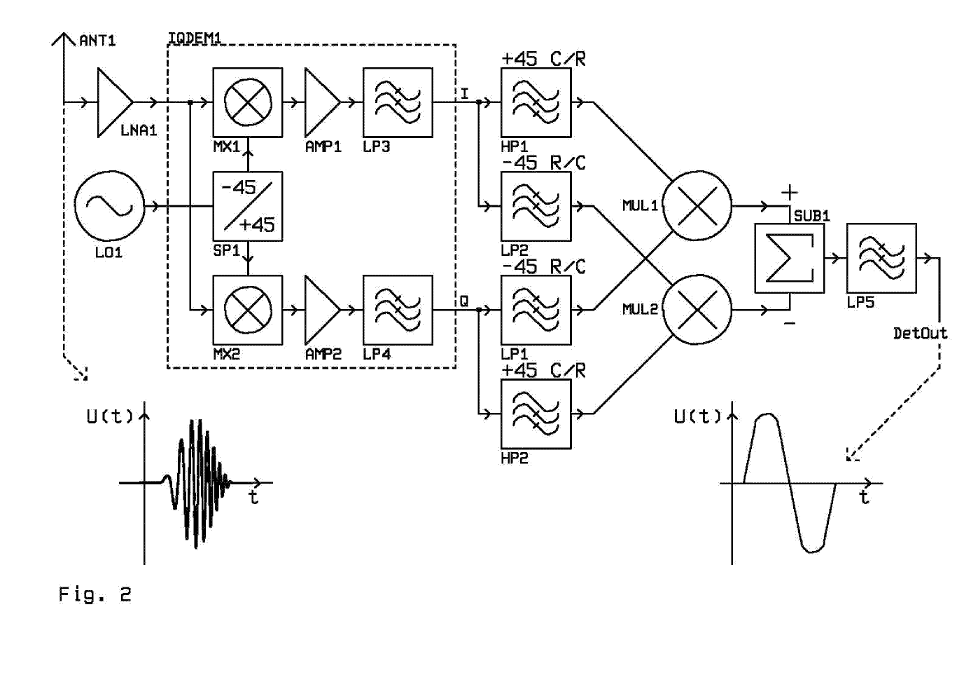

When using Chirp pulses in a radar with pulse compression it goes without saying that the pulses are limited in time. First, for example, the amplitude increases at e.g. the lowest frequency, then the frequency changes to the highest frequency, whereupon the amplitude is reduced again. For clarification, see the input signal on the ANT1 antenna shown in FIG. 2 over time.

In the design of an FMCW radar system, chirp signals are also used, which are transmitted continuously—CW—as a linearly increasing and then again linearly decreasing frequency. The distance of the object and the Doppler offset of the frequency for moving objects can be determined directly by mixing the received signal with the transmitting signal and assignment to the increasing or decreasing component, compare U.S. Pat. No. 4,106,020A.

Another possibility for detection in comparison to the above mentioned pulse compression filter is the vector demodulation of the received pulse by means of an I/Q quadrature demodulator, also called vector demodulator. This consists of two mixers, which are fed with the same local oscillator signal, but phase-shifted by 90 degrees in a mixer. At the output you get the usual analytical signal—easy to calculate in the complex number plane.

According to the current state of the art, this signal is usually fed to digital signal processing immediately after comparatively coarse low-pass filtering in order to comply with the Nyquist criterion and analog-to-digital conversion, where it is correlated, for example. Examples of this are EP1490708B1 and EP0472024A2, each in connection with radar systems.

However, a disadvantage of digital signal processing is the high latency time of the detector due to the converters as well as calculation processes and the quantization of the sampling clock, which may require a complex additional processing to determine the exact time of the pulse input. Added to this is the high power consumption of the broadband analog/digital converters with a high bandwidth of the chirp signal.

There are therefore also analog approaches with I/Q quadrature demodulators, for example U.S. Pat. No. 4,333,080A. However, the disadvantage here is again the high and above all indefinite latency time due to the use of a delay line, which in the analog case is inherently associated with inaccuracies.

For the implementation of the system described in the first part, the use of chirp pulses is generally desirable, however, with the state of the art, there is the problem that all implementations of a chirp detector suffer from the aforementioned problems, which make use difficult or prevent it, especially with short signal propagation times in the near-distance range. In particular, the relation of the processing time to the signal propagation time must be maintained.

In accordance with the invention, the problem is solved by the system described in claims 21 to 30, the function of which is explained below using a design example:

The example in FIG. 2 shows an inventive system. The incoming chirp pulse is first picked up by the ANT1 antenna, brought to an acceptable signal level in the LNA1 amplifier and then fed to the IQDEM1 I/Q quadrature demodulator.

This consists of the two MX1 and MX2 mixers, whose conversion loss is compensated by two subsequent AMP1 and AMP2 amplifiers, and a phase splitter SP1, which sends the signal provided by the local oscillator LO1 to the two mixers for frequency conversion in a version shifted by +45 degrees and −45 degrees respectively. The mixers then generate sum and difference frequencies, whereby only the difference frequencies are relevant in the following. In the common quadrature demodulators, the high sum frequencies are usually removed by the limited bandwidth of the I and Q output drivers or by additional LP3 and LP4 low-pass filters.

Another possibility is to use a local oscillator with double frequency like the Chirp center frequency and use a phase-shifting frequency divider as SP1, which evaluates both the positive and the negative edge of the input signal. Integrated circuits are also known, which first triple the local oscillator frequency and then divide it as described above. In the following, however, the local oscillator frequency should always be that internal frequency applied to the mixers (MX1, MX2) of the quadrature demodulator at which an input signal in turn generates I and Q output signals of the quadrature demodulator with 0 Hz—i.e. direct voltages dependent on the phase relation.

In the implementation preferred according to underclaim, one I output signal of the I/Q quadrature demodulator is now fed to a phase shifting high pass filter HP1 and the other Q output signal to a phase shifting low pass filter LP1. The sum of the phase shift of both filters in relation to each other is approx. 90 degrees.

The corresponding sum phase shift can be easily achieved by using two first order R/C filters, where the total phase shift of 90 degrees at the same 3 dB cut-off frequency is inherent. Techniques for integrating these are known from the implementation of splitter networks—similar to the splitter SP1 used in the I/Q quadrature demodulator.

Both signal paths are then merged by a MUL1 multiplier, whose output now surprisingly provides a very accurate signal for the detection of the chirp pulse in real time.

Because of the additional phase shift of the outputs, both output signals of the I/Q quadrature demodulator are in phase, so the frequency of the chirp signal is below the frequency of the local oscillator, and exactly 180 degrees out of phase, if the frequency of the chirp signal is above the frequency of the local oscillator.

If both frequencies match, a DC voltage signal is output, which is eliminated by the high-pass filter and leads to a zero product. Interference signals outside the pass band are also removed by the low-pass filter.

In a particularly preferred version of the invention, a second similar path is also implemented with a further MUL2 multiplier which, connected crosswise with the first, derives a further detection signal from a further phase-shifting high-pass filter HP2 such as low-pass filter LP2, which is generated in total with a phase offset of 90 degrees from the first detection signal.

By combining this second detection signal, negated in the result and phase-shifted by 90 degrees, with the first detection signal, preferably by subtraction, for which, depending on the sign position, an adder can also be used, especially with symmetrical signal outputs of the components, the gaps in the detection signal, which result from the effective squaring of the I/Q signals, are filled by the respective other detection signal.

This results in a geometric addition and therefore a total detection signal of high quality due to the squaring carried out in the multipliers. The necessary adders are usually integrated on common analog multiplier devices.

Surprisingly, a detection signal with extremely low latency and very high temporal precision is available due to the arrangement according to the invention.

The summed output signal can optionally be filtered with a low-pass LP5 to reduce the ripple caused by component deviations due to tolerances from the geometric sum. However, a rather high cut-off frequency and the shortest possible group delay should be used in order not to negatively influence the basically high temporal accuracy of the zero crossing by e.g. temperature-dependent fluctuating group delays of simple filters.

The detector according to the invention thus generates an output signal which—see FIG. 2, diagram at the DetOut signal—first rises to a value above the zero line when a chirp pulse arrives, then cuts it exactly when the chirp frequency matches the local oscillator frequency and then strikes out almost symmetrically on the underside of the zero line in order to return to the end of the pulse.

With a suitable additional circuit consisting of a comparator (CMP2) and a flip-flop (DFF1), a very precise digital detection signal can be obtained according to subclaim.

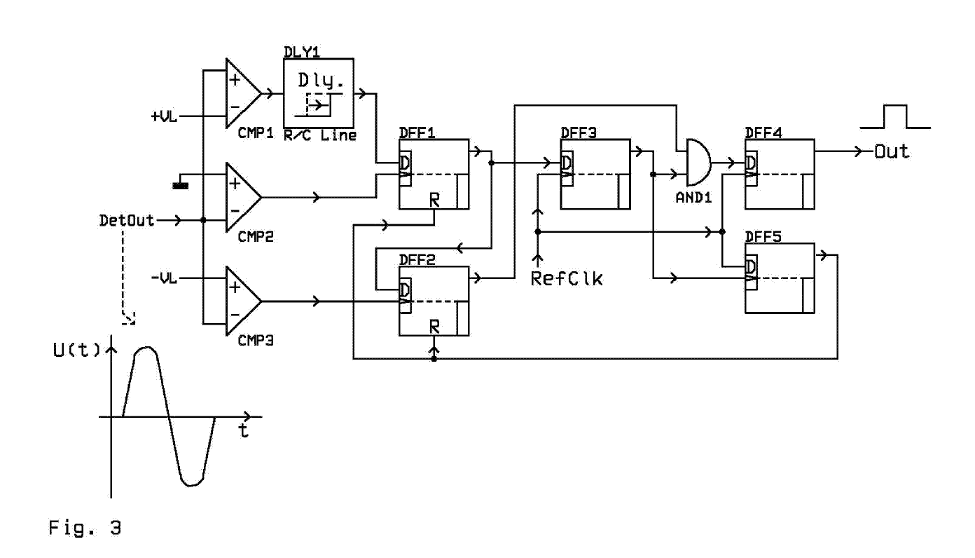

As shown in FIG. 3, this can be evaluated for conformity in a particularly advantageous design of the invention according to subclaim, also with regard to the overall signal form, in order to largely prevent the response to external interference signals.

In this example, the positive threshold value is detected by the comparator CMP1 and delayed to the time of zero crossing detected by the comparator CMP2 by a delay element DLY1, which can also be a simple R/C element with the following Schmitt trigger. The D-Flip-Flop DFF1 is therefore set exactly when both the positive threshold value has been exceeded and the zero crossing has occurred. The setting process also takes place exactly at zero crossing.

In a further step, the D-Flip-Flop DFF2 is additionally set if the negative threshold value detected by the comparator CMP3 is exceeded. This provides a mask signal for further processing steps.

The time occurrence of the zero crossing in relation to a reference clock—compare the register clock in the transponder from DE102015013453—is now determined very precisely by the D-Flip-Flop DFF3. However, the zero crossing detected in this way is only accepted by D-Flip-Flop DFF4 in a further step if the presence of the negative component is also confirmed by the mask signal provided by D-Flip-Flop DFF2 and the complete signal is thus released for further acceptance by means of AND gate AND1.

Irrespective of this, in the schematic example in FIG. 2, the flip-flops are reset with the acceptance of the detected zero-crossing by the D-Flip-Flop DFF5 with a clock delay, whereby the register chain is always reset even after only partially detected pulses. Of course, the expert is free to introduce further criteria and timeouts for the recognition, masking and reset in a real implementation in order to increase the stability and quality of the evaluation.

To further improve the quality of detection, the threshold values of the comparators CMP1 and CMP3 can be determined adaptively, e.g. by the noise level of the I and Q outputs of the quadrature demodulator without applied pulse.

Another possibility is the use of fast scanning (S/H) analog-to-digital converters, which do not even require a particularly high data rate, and the digital evaluation of the signal form, if necessary, independent of the very precise evaluation of the zero crossing over time. Since a subsequent masking is possible here, sufficient time is available for the digital signal processing, so that e.g. the correlation with a pattern pulse is also conceivable.

Thus, when a reference clock edge is present at the clock input of the DFF3 D-Flip-Flop, it is decided very precisely whether a system-compliant chirp pulse has arrived exactly before or after the edge, just as is required for delay time measurement in DE102015013453. With this flip-flop, it is essential to ensure that no metastable conditions can occur overall.

Another additional use of the detector is to allow not only chirp pulses with increasing but also those with decreasing frequency over time in order to transmit control information for the transponders back to the interrogation unit with the direction of the signal passage of the detection signal, e.g. control information for the transponders or vice versa acknowledgement information or measured values. In this case, this can be done by evaluating the direction of the zero crossing. When using the logic from FIG. 2, you only need to double the logic shown there after the comparators. For the second instance, the outputs of the comparators CMP1 and CMP3 are then swapped and the signal of the comparator CMP2 is inverted. It is also conceivable to use two SAW pulse compression filters for separate evaluation, as known from the state of the art.

Another way of using pulses of both rising and falling frequency is to evaluate the difference to determine the Doppler influence and thus to determine the speed of the moving transponder, if necessary.

The invention thus also provides a high-precision detector to enable high-precision distance determination using radio signals at close range or within closed spaces using chirp pulses.

1. System for determining position or measuring distance by time of flight measurement, or interrogation unit or transponder of such a system,
the system consisting of at least one interrogation unit and at least one transponder,
wherein the interrogation unit transmits an interrogation signal to the transponder by means of radio, sound or light, which is also answered by the latter with a response signal by radio, sound or light, which in turn is received by the interrogation unit, wherein the time between interrogation and response is determined and the distance between interrogation unit and transponder is calculated therefrom,
whereby
the query unit first generates or creates the queries internally in a fixed time grid, however individual queries may be omitted in this grid,
the interrogation unit has at least one variable delay element for the queries generated in this grid, which enables a variable shift in time of the interrogation signal before transmission,
the transponder delays the received queries in at least one clocked register chain, consisting of at least one clocked digital or analog register—including D-flip-flop, sample/hold, CCD and ADC—and triggers the response with the so delayed signal,
this register chain is clocked in the transponder from a local register clock, which is in fixed frequency relation to the time grid of the interrogation unit, but does not have to be phase synchronous, and
with the aid of the variable delay element in the interrogation unit, the optimum point in time is sounded out at which an immediate acceptance of the request in the register chain takes place exactly at one clock edge of the register clock or, with a slight additional delay, a time jump from a further register clock period of the received response signal occurs,
wherein a highly precise delay in the transponder is thus achieved, enabling a high-precision measurement of the round trip signal propagation time.

2. System or interrogation unit or transponder according to claim 1, whereby the sounding out of the optimum point in time is essentially carried out by a binary search of the delay to be applied within a defined time interval.

3. System or interrogation unit or transponder according to claim 1, whereby the register chain in combination with logic gates generates a response signal only in response to a specific interrogation pattern, wherein different transponders can react to different interrogation patterns by different combinations of the—optionally also programmable—logic.

4. System or interrogation unit or transponder according to claim 1, whereby the interrogation or response signal is substantially pulse-modulated or modulated with a phase change for signaling the interrogation and response time.

5. System or interrogation unit or transponder according to claim 1, whereby the local register clock in the transponder is coupled to the pulse frequency or carrier frequency or another characteristic of the interrogation signal by means of a phase or frequency control loop and thus its frequency is kept synchronous with the time grid of the interrogation unit.

6. System or interrogation unit or transponder according to claim 1, whereby the interrogation signal according to the delay element is used as a trigger for fast signal recording of the response signal.

7. System or interrogation unit or transponder according to claim 1, whereby the position is determined by triangulation.

8. System for measuring the distance by measuring the propagation time of a radio signal, or interrogation unit or transponder of such a system, the system consisting of at least one interrogation unit and at least one transponder, the interrogation unit emitting an interrogation signal to the transponder, which is answered by the transponder with a response signal, which in turn is received by the polling unit, whereby the time between polling and response is determined and the distance between polling unit and transponder is calculated therefrom, whereby the polling unit first creates the requests internally in a fixed time grid, the polling unit has at least one variable delay element for the queries thus generated, which makes it possible to shift the interrogation signal, which initially obeys the time grid, variably in time in the grid and then to transmit it, the transponder delays the queries received in at least one clocked register chain and triggers the response with the signal thus delayed, this register chain is clocked in the transponder from a local register clock, which is in fixed frequency relation to the time grid of the interrogation unit, the variable delay element in the interrogation unit is used to sound out the optimum point in time at which an immediate acceptance of the request in the register chain occurs exactly at one clock edge of the register clock by means of a clock signal in the transponder,
whereby broadband, broadband pulsed, OFDM or ultra wideband radio signals are used.

9. System or interrogation unit or transponder according to claim 1, whereby feedback of the own transmission signal to the receiver of the transponder is avoided by deactivating it beforehand, during and/or after transmission or by resetting the existing register chain in the transponder after transmission.

10. System or interrogation unit or transponder according to claim 1, whereby a correlation with a known signal or an autocorrelation is used to determine the input of an interrogation signal.

11. System or interrogation unit or transponder according to claim 1, whereby for precise detection of the response signal in the interrogation unit, the clock of the ADC converter (DSO-ADC1) recording the response together with its trigger signal is delayed via a further variable delay element, which is identical in construction to the existing delay element (VDLY1) and is controlled in the same way, such further delay elements can also be used to adapt further clocks and oscillations of the system such as high-frequency carriers of the transmitter or receiver, PLL reference clocks or clock signals to pulse-forming digital-to-analog converters.

12. System or interrogation unit or transponder according to claim 1, whereby an integration into an existing standard data transmission system such as IEEE WLAN, ETSI LTE or Bluetooth is carried out by interpreting a signal characteristic or the beginning of the packet as an interrogation or response pulse.

13. A detector for chirp pulses, particularly suitable for a system for distance measurement by delay measurement of a radio signal, consisting of at least one I/Q quadrature demodulator (IQDEM1) fed by at least one local oscillator (LO1) with downstream evaluation circuit
here always the inner frequency locally present at the mixers (MX1, MX2) of the quadrature demodulator is named local oscillator frequency, regardless if the local oscillator frequency fed into the component from outside is previously internally multiplied or divided—,
whereby
in the subsequent evaluation circuit between both I and Q outputs of the quadrature demodulator a phase shift of approximately 90 degrees—if necessary plus an integer multiple of 180 degrees—is first generated by a phase shifter and/or filter (HP1, LP1) and the outputs thus phase-shifted are combined in at least one multiplier (MUL1, MUL2) or mixer,
wherein the output signal of the detector has a zero crossing when the local oscillator frequency is reached by the chirp frequency.

14. A detector for chirp pulses according to claim 13, whereby an output of the quadrature demodulator is phase-shifted by means of at least one high-pass filter (HP1, HP2).

15. A detector for chirp pulses according to claim 13, whereby an output of the quadrature demodulator is phase-shifted by means of at least one low-pass filter (LP1, LP2).

16. A detector for chirp pulses according to claim 13, whereby high and low pass filters used for phase-shifting are first order R/C filters or R/C filter networks with an inherent phase offset between both paths of 90 degrees in sum.

17. A detector for chirp pulses according to claim 13, whereby each I and Q output of the quadrature demodulator (IQDEM1) is supplied symmetrically to at least one high-pass filter (HP1, HP2) or first phase shifter and at least one low-pass filter or second phase shifter (LP1, LP2), then at least two multipliers (MUL1, MUL2) or mixers each multiply the signal of such a filtered or phase-shifted I output crosswise by the signal of such a filtered or phase-shifted Q output and the output signals of the multipliers or mixers are subtracted (SUB1) or added to obtain a high quality total detection signal.

18. A detector for chirp pulses according to claim 13, whereby the output signal is evaluated in the subsequent evaluation circuit for exceeding a minimum level in positive and negative direction, for which purpose comparators (CMP1, CMP3) which compare against at least one fixed or adaptively determined limit value (+VL, −VL) can be used.

19. A detector for chirp pulses according to claim 13, whereby the direction of the zero-crossing of the detection signal (SUB1, LP5) generated by at least one multiplier (MUL1, MUL2) or mixer and post-processed as required, which describes the direction of the frequency change of the chirp, is evaluated as a digital signal for additional data transmission.

20. A detector for chirp pulses according to claim 13, whereby in any case individual parts of the signal processing are performed after analog-to-digital conversion by means of digital signal processing, wherein mixers can be replaced by digital multipliers and filters such as phase shifter by digital FIR, IIR and CIC filters and FIFO memory for targeted signal delay and oscillator signals can be generated by means of direct digital synthesis.
